(19) United States
(12) Patent Application Publication
(10) Pub. No.: US 2024/0346797 A1
(43) Pub. Date: Oct. 17, 2024

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: DAISUKE SATO, Kanagawa (JP)

(21) Appl. No.: 18/632,028

(22) Filed: Apr. 10, 2024

(30) Foreign Application Priority Data
Apr. 13, 2023 (JP) 2023-065876

(51) Int. Cl. G06V 10/25; G06T 5/50; G06T 7/11; G06T 7/70

(52) U.S. Cl. CPC G06V 10/25; G06T 5/50; G06T 7/11; G06T 7/70; G06T 2207/20221; G06V 2201/07

(57) ABSTRACT

An information processing apparatus includes one or more memories storing instructions, and one or more processors that execute the instructions to determine whether a series of records of a previously executed detection process related to detection of a detection target from an image includes a record of a second detection process with a condition related to the detection of the detection target from the image, at least some of which overlaps with a condition of a first detection process based on a process request from a user, and present information about the second detection process to the user in a case where it is determined that the record of the second detection process with the condition at least some of which overlaps with the condition of the first detection process is included.

### BACKGROUND OF THE DISCLOSURE

### Field of the Disclosure

The present disclosure relates to an information processing apparatus, a method for controlling the information processing apparatus, and a storage medium.

### Description of the Related Art

In inspecting infrastructure constructions, such as bridges and tunnels, inspectors conventionally stand by a wall of an infrastructure construction, visually inspect the wall for defects, such as cracks, and record the inspection. This inspection operation, called close visual inspection, costs a lot. To address this issue, there has been proposed a technique of automatically detecting defects in a wall of an infrastructure construction as an inspection target by performing image processing and inference processing on captured images of the wall of the infrastructure construction. Japanese Patent No. 6099479 discusses a technology of detecting a defect region in captured images of an infrastructure construction through image processing based on setting values, such as thresholds and numerical ranges.

### SUMMARY

According to an aspect of the present disclosure, an information processing apparatus includes one or more memories storing instructions, and one or more processors that execute the instructions to determine whether a series of records of a previously executed detection process related to detection of a detection target from an image includes a record of a second detection process with a condition related to the detection of the detection target from the image, at least some of which overlaps with a condition of a first detection process based on a process request from a user, and present information about the second detection process to the user in a case where it is determined that the record of the second detection process with the condition at least some of which overlaps with the condition of the first detection process is included.

Further features of the present disclosure will become apparent from the following description of exemplary embodiments with reference to the attached drawings.

### BRIEF DESCRIPTION OF THE DRAWINGS

FIG. 1 is a functional block diagram illustrating an example of a functional configuration of an information processing apparatus according to a first exemplary embodiment.

FIG. 2 is a diagram illustrating an example of a hardware configuration of the information processing apparatus according to the first exemplary embodiment.

FIG. 3 is a flowchart illustrating an example of a process in the information processing apparatus according to the first exemplary embodiment.

FIG. 4 is a diagram illustrating an example of process record information according to the first exemplary embodiment.

FIG. 5 is a flowchart illustrating an example of a process in the information processing apparatus according to the first exemplary embodiment.

FIG. 6 is a diagram illustrating an example of a screen for presenting information to users according to the first exemplary embodiment.

FIGS. 7A and 7B are diagrams illustrating an example of a screen for presenting information to users according the first exemplary embodiment.

FIG. 8 is a diagram illustrating an example of a screen for presenting information to users according to the first exemplary embodiment.

FIG. 9 is a functional block diagram illustrating an example of a functional configuration of an information processing apparatus according to a second exemplary embodiment.

FIG. 10 is a flowchart illustrating an example of a process performed by the information processing apparatus according to the second exemplary embodiment.

FIG. 11 is a flowchart illustrating an example of a process performed by an information processing apparatus according to a third exemplary embodiment.

FIGS. 12A and 12B are diagrams illustrating an example of a screen related to receiving a detection process request according to the third exemplary embodiment.

FIG. 13 is a flowchart illustrating an example of a process performed by an information processing apparatus according to a fourth exemplary embodiment.

FIG. 14 is a diagram illustrating an example of a screen for presenting information to users according to a fifth exemplary embodiment.

### DESCRIPTION OF EMBODIMENTS

Exemplary embodiments of the present disclosure will be described in detail with reference to the attached drawings.

In the present specification and the drawings, components having substantially the same functional configuration are given the same reference numeral, and the redundant descriptions thereof will be omitted.

A first exemplary embodiment of the present disclosure will be described.

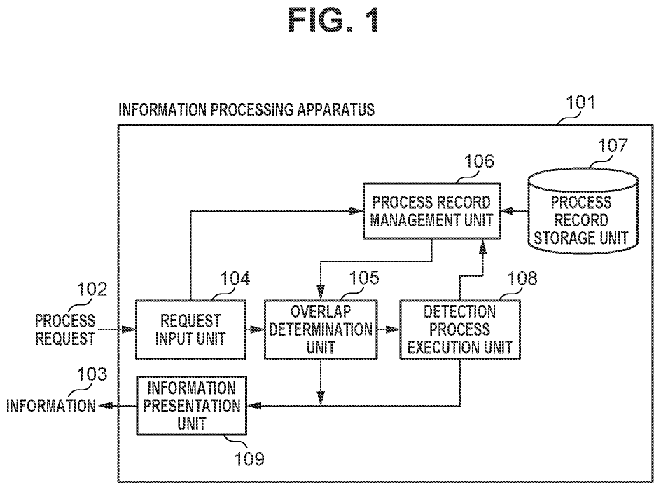

First, an example of a functional configuration of an information processing apparatus according to the present exemplary embodiment will be described with reference to FIG. 1. An information processing apparatus 101 according to the present exemplary embodiment includes a request input unit 104, an overlap determination unit 105, a process record management unit 106, a process record storage unit 107, a detection process execution unit 108, and an information presentation unit 109. A process request 102 indicates a process request that is an input to the information processing apparatus 101. Information 103 indicates information that is an output from the information processing apparatus 101. For example, information indicating a result of a process executed based on the process request 102 can correspond to the information 103.

The request input unit 104 receives the process request 102 from a user. As a specific example, the request input unit 104 can receive, as the process request 102, a process request related to detection of detection targets (e.g., objects that match specified conditions) from images from the user. In this case, the process request 102 can include, for example, an image that is an application target of a detection process and process parameters that are applied in executing the detection process. Hereinafter, for convenience, a process request for a process related to detection of an object from an image (hereinafter, the process will also be referred to simply as “detection process”) is received as the process request 102.

The process record storage unit 107 is a storage area storing records of various processes executed previously (hereinafter, the records will also be referred to as “process records”). As a specific example, the process record storage unit 107 can store process records of object detection processes on images executed previously by the detection process execution unit 108 described below.

The process record management unit 106 manages the process records stored in the process record storage unit 107.

The overlap determination unit 105 determines whether conditions specified for the detection process in the process request 102 received by the request input unit 104 overlap with at least some of conditions applied to a detection process executed based on a process request received previously. Details of the process by the overlap determination unit 105 will be described below.

The detection process execution unit 108 executes an object detection process on an image based on a determination result of the overlap determination unit 105 using the parameters included in the process request 102.

The information presentation unit 109 receives outputs from the overlap determination unit 105 and the detection process execution unit 108 and outputs the information 103 based on the received outputs to a predetermined output destination to present the information 103 to the user.

The configuration illustrated in FIG. 1 is a merely example and is not intended to limit the functional configuration of the information processing apparatus 101 according to every embodiment. For example, the configuration illustrated in FIG. 1 can be realized through collaboration of a plurality of devices. As a specific example, some of the components illustrated in FIG. 1 can be realized with another apparatus different from the information processing apparatus 101. As a specific example in this case, the functions of recording and managing the process records of the detection processes (e.g., the process record storage unit 107, the process record management unit 106) can be realized with another apparatus different from the information processing apparatus 101. Further, as another example, the processing load of at least some of the components illustrated in FIG. 1 can be distributed across a plurality of devices. Further, as another example, at least some of the components illustrated in FIG. 1 can be realized with a so-called network service, such as a cloud service.

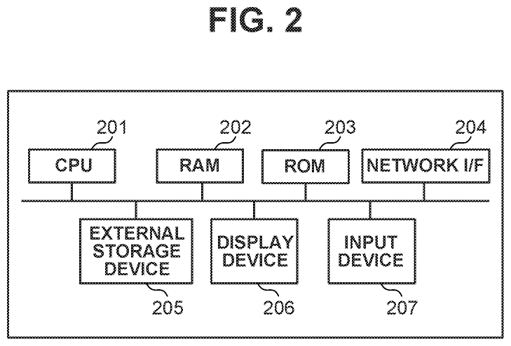

Next, an example of a hardware configuration of the information processing apparatus 101 according to the present exemplary embodiment will be described with reference to FIG. 2.

The information processing apparatus 101 includes a central processing unit (CPU) 201, a random-access memory (RAM) 202, and a read-only memory (ROM) 203. Further, the information processing apparatus 101 includes a network interface (network I/F) 204, an external storage device 205, a display device 206, and an input device 207.

The CPU 201 controls operations of the components of the information processing apparatus 101. Further, the CPU 201 is an entity that executes various processes described below as processes that the information processing apparatus 101 performs.

The RAM 202 is a storage area for temporarily storing data and control information and can function as, for example, a work area for use in executing various processes by the CPU 201.

The ROM 203 is a storage area for storing various information and programs. For example, the ROM 203 stores fixed operation parameters that are applied to operations of the information processing apparatus 101 and operation programs related to operations of the information processing apparatus 101.

The network I/F 204 is a network I/F for connecting the information processing apparatus 101 to a predetermined network and provides, for example, a function for transmitting and receiving data to and from external devices via the network.

The external storage device 205 is a storage device configured to store various data and includes an interface for receiving input/output (I/O) commands for reading data and writing data. The external storage device 205 can be realized with, for example, a hard disk drive (HDD), a solid-state drive (SSD), an optical disk drive, and a semiconductor storage device. The foregoing storage devices are merely examples, and the external storage device 205 can be realized with another storage device different from the storage devices described above as examples. The external storage device 205 stores, for example, computer programs to be executed by the CPU 201 and data to be applied to processes in order to carry out the processes described below as processes that the information processing apparatus 101 performs.

The display device 206 is realized with, for example, a display device, such as a liquid crystal display (LCD), and plays a role as an output interface that displays various information as images to present the information to the user.

The input device 207 is realized with, for example, an input device, such as a keyboard, a mouse, and a touch panel, and plays a role as an input interface that receives inputs from the user.

The configuration illustrated in FIG. 2 is a merely example and is not intended to limit the hardware configuration of the information processing apparatus 101 according to every embodiment. For example, components other than the components illustrated as examples in FIG. 2 can be added based on functions that the information processing apparatus 101 carries out. Further, as another example, some of the components illustrated in FIG. 2 (e.g., the display device 206, the input device 207) can be realized with an external device attached externally to the information processing apparatus 101.

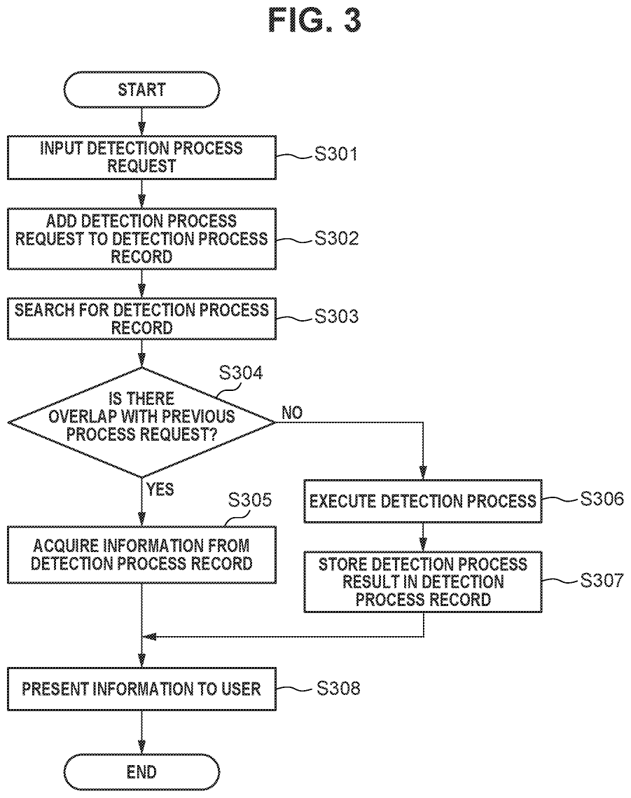

An example of a process performed by the information processing apparatus 101 according to the present exemplary embodiment will be described with reference to FIG. 3, focusing especially on a process related to detection of objects from images. For convenience, various descriptions of the present exemplary embodiment focus on a case of detecting defects (e.g., cracks) in a construction, such as a tunnel or a bridge, in a situation in which an inspection of the construction is performed. Meanwhile, application targets of the technologies according to the present disclosure are not limited to the detection of detects in constructions described above. As a specific example, the technologies according to the present disclosure are applicable to detection of damage or dirt on products, such as crops, in images and to detection of lesions from medical images. Further, while a single person performs operations according to the present exemplary embodiment for convenience, this is not intended to limit use forms of the information processing apparatus 101 according to the present exemplary embodiment. For example, the technologies according to the present disclosure are still applicable even in a situation in which a plurality of users belonging to the same group shares images and detection process records.

In step S301, the request input unit 104 receives, from the user, a process request (hereinafter, also referred to as “detection process request”) specifying an image that is an application target of an object detection process and process parameters that are applied in executing the detection process. According to the present exemplary embodiment, an image that is a target of the detection process is specified by specifying image identification information assigned in advance to the uploaded image. The method is not particularly limited, and any method capable of specifying an image that is a target of the detection process can be used. As a specific example, a file of an image that is a target of the detection process can be received together with the detection process request.

In step S302, the request input unit 104 requests the process record management unit 106 to store the received input detection process request in the process record storage unit 107.

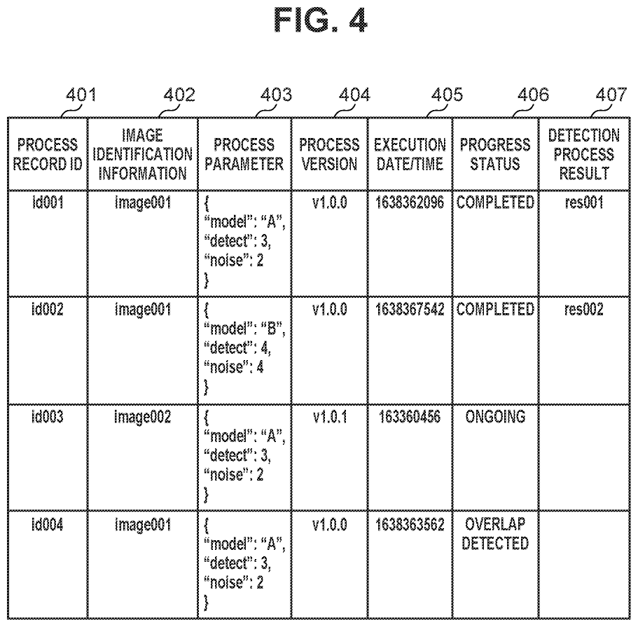

An example of process record information stored in the process record storage unit 107 will be described with reference to FIG. 4. The process record information includes a process record identifier (process record ID) 401, image identification information 402, a process parameter 403, a process version 404, an execution date/time 405, a progress status 406, and a detection process result 407.

The process record ID 401 is identification information for uniquely identifying a process record and is assigned individually to each process record.

The image identification information 402 is identification information for uniquely identifying an image that is a target of a detection process.

As the image identification information 402, information, such as an identifier (ID) assigned to a target image in registering the target image in the information processing apparatus 101, an image file name, or an image file hash value, can be applied.

The process parameter 403 is a process parameter specified as an application target in executing a detection process. The process parameter 403 is, for example, a process parameter that is specified in a process request by the user and is stored as information in a predetermined format (e.g., text in a predetermined format).

The process version 404 is information indicating a version of a process library used in executing a detection process by the detection process execution unit 108. For example, even when the same parameters are applied in executing detection processes, different versions of applied process libraries can change results of the detection processes. Thus, according to the present exemplary embodiment, the process version 404 is included in the process record information and is used in an overlap determination process described below.

The execution date/time 405 is information indicating an execution date and time of a detection process.

The progress status 406 is information indicating a progress status of a target detection process. As the progress status 406, information, such as “pending”, “ongoing”, “completed”, or “failed”, can be set based on the progress status of the target detection process.

The detection process result 407 is information indicating a process result obtained through the target detection process. As the detection process result 407, for example, vector data in which the detection result is recorded or a detection result image file with the detection result superimposed on the target image can be set.

FIG. 3 will be referred to again.

In step S303, the overlap determination unit 105 requests the process record management unit 106 to search the series of detection process records stored in the process record storage unit 107 for a detection process record with a condition related to execution of the detection process that overlaps with a condition of the detection process request received in step S301. Specifically, the overlap determination unit 105 searches the series of detection process records stored in the process record storage unit 107 for a detection process record of a detection process in which the same parameters are applied to the same image as in the detection process request received in step S301, and the overlap determination unit 105 extracts the detected detection process record. As a method for determining whether images are the same image, a determination method based on whether the image identification information matches is applied according to the present exemplary embodiment. The method is not particularly limited, and any method capable of determining whether images are the same image can be used. For example, whether images are the same image can be determined using image file names, file sizes, or a result of measuring a similarity between the images.

In step S304, the overlap determination unit 105 executes an overlap determination process based on the detection process record search result in step S303 to determine whether the condition of the detection process specified in the detection process request received in step S301 overlaps with a condition of a detection process executed previously. As a specific example, the overlap determination unit 105 can determine whether the parameters of the detection process specified in the detection process request overlap with parameters applied to a detection process executed previously.

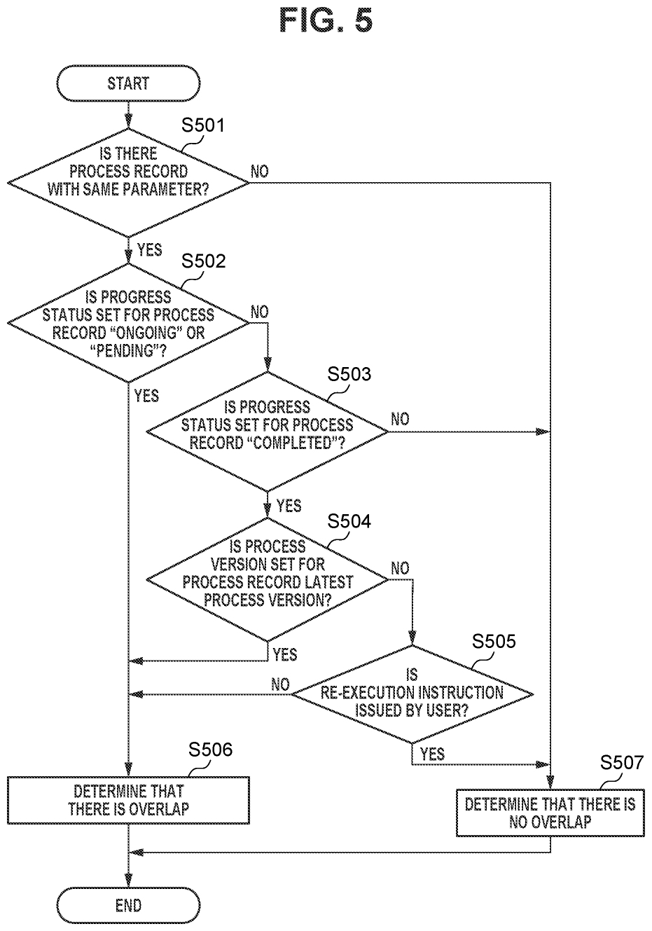

An example of the overlap determination process described as step S304 in FIG. 3 will be described with reference to FIG. 5.

In step S501, the overlap determination unit 105 checks whether the series of process records stored in the process record storage unit 107 includes a process record of a detection process executed on the same image using the same parameters as in the detection process request received in step S301 in FIG. 3.

If the overlap determination unit 105 determines that no process record of a detection process executed on the same image using the same parameters as in the detection process request is included (NO in step S501), the processing proceeds to step S507.

In this case, the overlap determination unit 105 determines that there is no overlap in step S507, and then the process in FIG. 5 is ended.

On the other hand, if the overlap determination unit 105 determines that a process record of a detection process executed on the same image using the same parameters as in the detection process request is included (YES in step S501), the processing proceeds to step S502.

In step S502, the overlap determination unit 105 determines whether the progress status set for the target process record (i.e., the process record determined to be included in step S501) corresponds to “ongoing” or “pending”.

In step S502, if the overlap determination unit 105 determines that the progress status set for the target process record corresponds to “ongoing” or “pending” (YES in step S502), the processing proceeds to step S506.

In this case, the overlap determination unit 105 determines that there is an overlap in step S506, and then the series of processes in FIG. 5 is ended.

On the other hand, in step S502, if the overlap determination unit 105 determines that the progress status set for the target process record is neither “ongoing” nor “pending” (NO in step S502), the processing proceeds to step S503.

In step S503, the overlap determination unit 105 determines whether the progress status set for the target process record (i.e., the process record determined to be included in step S501) is “completed”.

In step S503, if the overlap determination unit 105 determines that the progress status set for the target process record is not “completed” (NO in step S503), the processing proceeds to step S507. In this case, the overlap determination unit 105 determines that there is no overlap in step S507, and then the series of processes in FIG. 5 is ended.

On the other hand, in step S503, if the overlap determination unit 105 determines that the progress status set for the target process record is “completed” (YES in step S503), the processing proceeds to step S504.

While cases where the progress status set for the target process record is a status other than “ongoing”, “pending”, and “completed” according to the present exemplary embodiment are not described in detail herein, processes for the cases of the other statuses can be added as appropriate. As a specific example, a process of notifying the user of a warning indicating that a detection process executed previously using parameters similar to the parameters in the received process request failed when the progress status is “failed” can be added.

In step S504, the overlap determination unit 105 determines whether the process version set for the target process record matches the process version (latest process version) of the detection process that the detection process execution unit 108 executes.

In step S504, if the overlap determination unit 105 determines that the process version set for the target process record matches the latest version (YES in step S504), the processing proceeds to step S506. In this case, the overlap determination unit 105 determines that there is an overlap in step S506, and then the series of processes in FIG. 5 is ended.

On the other hand, in step S504, if the overlap determination unit 105 determines that the process version set for the target process record does not match the latest version (NO in step S504), the processing proceeds to step S505.

In step S505, if the process version set for the target process record and the latest process version differ from each other, the overlap determination unit 105 checks whether to re-execute the detection process.

In step S505, if the overlap determination unit 105 determines that a re-execution instruction is issued by the user (YES in step S505), the processing proceeds to step S507. In this case, the overlap determination unit 105 determines that there is no overlap in step S507, and then the series of processes in FIG. 5 is ended.

On the other hand, in step S505, if the overlap determination unit 105 determines that no re-execution instruction is issued by the user (NO in step S505), the processing proceeds to step S506. In this case, the overlap determination unit 105 determines that there is an overlap in step S506, and then the series of processes in FIG. 5 is ended.

The method for checking with the user whether to re-execute the process is not particularly limited. As a specific example, a confirmation dialog can be presented to the user to determine whether to re-execute the process based on an instruction received from the user via the dialog.

Further, while FIG. 5 illustrates an example of a case where whether to re-execute the process when the version differs is determined each time, whether to re-execute the process when the version differs can be determined based on predetermined settings.

FIG. 3 will be referred to again.

In step S304, if the overlap determination unit 105 determines that the condition of the detection process specified in the detection process request overlaps with a condition of a detection process executed previously (YES in step S304), the processing proceeds to step S305.

On the other hand, in step S304, if the overlap determination unit 105 determines that the condition of the detection process specified in the detection process request does not overlap with a condition of a detection process executed previously (NO in step S304), the processing proceeds to step S306.

In step S305, the overlap determination unit 105 acquires information about the detection process executed previously from the target detection process record. The information about the detection process executed previously that is acquired in step S305 can be, for example, progress status information, initiation date/time information, and result information about the process.

In step S306, the detection process execution unit 108 executes a detection process (e.g., a process related to detection of defects in target objects) on the target image using the specified parameters based on the detection process request.

In step S307, the detection process execution unit 108 requests the process record management unit 106 to store a detection process record based on a result of the detection process in step S306 in the process record storage unit 107.

Then, the detection process execution unit 108 updates the progress status in the detection process record and adds the process version to the detection process record.

In step S308, the information presentation unit 109 presents, to the user, information indicating the result of the process executed based on the detection process request received in step S301.

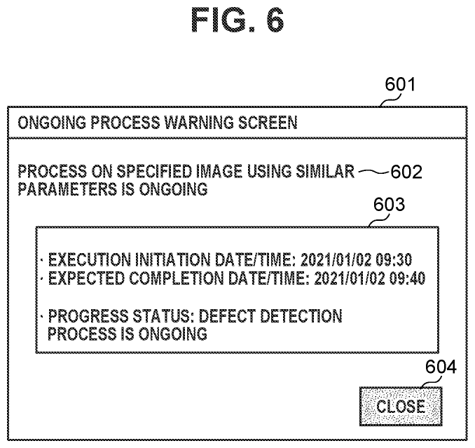

An example of an ongoing process warning screen that is displayed by the information presentation unit 109 to present information to the user if it is determined that the condition of the detection process specified in the detection process request overlaps with a condition of an ongoing or pending detection process will be described with reference to FIG. 6.

A form 601 is a warning form for presenting information to the user by the information presentation unit 109 if there is an ongoing or pending process with a condition similar to (e.g., parameter similar to) the condition of the detection process specified in the detection process request.

A message 602 is a message indicating specific warning details to the user. For example, in the example illustrated in FIG. 6, a warning indicating that a detection process is ongoing on the image specified in the process request received from the user using parameters similar to the parameters specified in the process request is displayed as the message 602.

A form 603 is a form for presenting a status of the ongoing or pending process to the user. In the example illustrated in FIG. 6, information indicating an initiation date/time of the process, a progress status of the process, and an expected completion date/time of the process is presented as information indicating the status of the ongoing detection process in the form 603. The information presented in the form 603 is not limited to those described above. For example, the process parameters applied to the ongoing or pending process or information indicating the user that has issued an instruction to execute the process can be presented in the form 603.

A button 604 is a button for closing the ongoing process warning screen.

The information presentation unit 109 can update the information presented on the ongoing process warning screen based on the execution status of the detection process that is a target of information presentation to the ongoing process warning screen. Further, the information presentation unit 109 can change the screen presented to the user from the ongoing process warning screen to an executed process warning screen described below if the target detection process is completed.

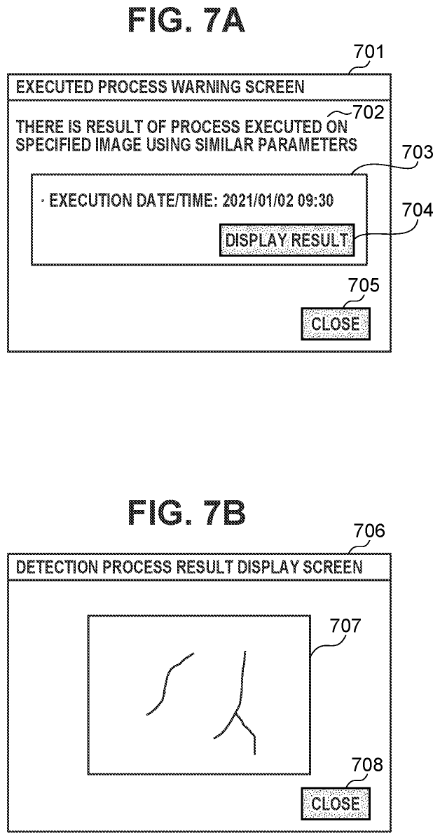

An example of a screen that is displayed by the information presentation unit 109 to present information to the user if it is determined that the condition of the detection process specified in the detection process request overlaps with a condition of an executed detection process will be described with reference to FIGS. 7A and 7B. First, an example of an executed process warning screen illustrated in FIG. 7A will be described.

A form 701 is a warning form for presenting information to the user by the information presentation unit 109 if there is a process executed using a condition similar to (e.g., a parameter similar to) the condition of the detection process specified in the detection process request.

A message 702 is a message indicating specific warning details to the user.

A form 703 is a form for presenting information about the executed process to the user. In the example illustrated in FIG. 7A, information indicating the execution date and time of the executed detection process is presented in the form 703. The information presented in the form 703 is not limited to the above-described information. For example, the process parameters applied to the executed process and/or information indicating the user that has issued an instruction to execute the process can be presented in the form 703.

A button 704 is a button for receiving, from the user, an instruction to display more detailed information about the executed process. If the button 704 is pressed, more detailed information about the executed process is displayed.

A button 705 is a button for closing the executed process warning screen.

An example of a detection process result display screen illustrated in FIG. 7B will be described. The detection process result display screen is an example of a screen that is displayed if the button 704 on the executed process warning screen in FIG. 7A is pressed.

A form 706 is a form for presenting more detailed information about the executed process.

A form 707 is a form where the detection process target image is displayed while the detection process result is superimposed on the detection process target image.

A button 708 is a button for closing the detection process result display screen.

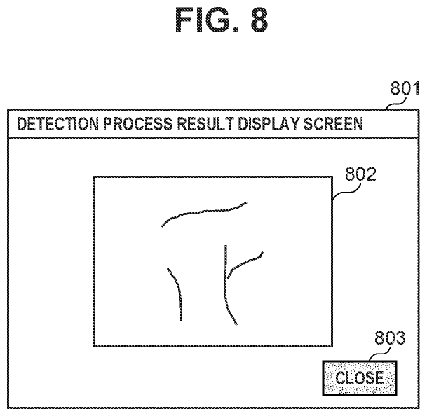

An example of a detection process result display screen that is displayed by the information presentation unit 109 to present information to the user if the detection process specified in the detection process request is executed will be described with reference to FIG. 8.

A form 801 is a form for presenting information based on the execution result of the detection process specified in the detection process request.

A form 802 is a form where the detection process target image is displayed while the detection process result is superimposed on the detection process target image.

A button 803 is a button for closing the detection process result display screen.

The information that is presented on the detection process result display screen is not limited to the examples described above, and other information can be presented. As a specific example, information indicating the detection process result can be displayed alone without superimposing the detection process result on the detection process target image. Further, the detection process result display screen can be provided with vector data indicating the detection process result or a user interface (UI) for downloading the detection process target image with the detection process result superimposed on the detection process target image.

As described above, the information processing apparatus according to the present exemplary embodiment makes it possible to prevent execution of a detection process requested by a user when the detection process requested by the user overlaps in condition with a detection process executed previously. Thus, even if, for example, the user does not realize that a detection process was executed previously using a similar condition and the user issues a request to execute the detection process, execution of the detection process is prevented, so that an effect of reducing the entire process time can be expected.

Further, in a situation in which a plurality of users collaborates on work, a user may issue a detection process request with a similar condition without realizing that another detection process is executed based on a request from another user. Even in this situation, the information processing apparatus according to the present exemplary embodiment prevents execution of the detection process with the condition similar to the condition of the detection process executed previously, so that an effect of reducing the entire process time can be expected.

Further, if a detection process that overlaps in condition with the pending or ongoing detection process is requested, execution of the detection process requested subsequently is prevented. Thus, even in a situation in which, for example, the user unintentionally issues requests for a process with the same condition one after another due to operational mistakes, execution of excessive processes (processes requested subsequently) is prevented, so that an effect of reducing the entire process time can be expected.

Further, since the process version at the time of executing the detection process is recorded in the process record, a different process version of the detection process executed previously from the latest version allows re-execution of the detection process even if similar process parameters are specified.

This makes it possible to prevent an occurrence of an incident where a result of a detection process of an old version is presented continuously to the user although the process version of the detection process has been updated to the latest version.

In the present disclosure, the process of detecting target objects from images can be efficiently executed.

A second exemplary embodiment according to the present disclosure will be described. In the first exemplary embodiment, the example above has described the case where, with a detection process request targeting a single image issued, whether there is an overlap in condition between the detection process specified in the detection process request and a detection process executed previously is determined. In the present exemplary embodiment, an example will be described of a case where a detection process is executed individually for each of a plurality of partial regions divided from a detection region that is a target of the detection process in an image and then a result of the detection process on the entire detection region is generated based on the results of the individual detection processes.

The present exemplary embodiment will be described focusing on differences of the present exemplary embodiment from the first exemplary embodiment, and the redundant detailed descriptions of those that are substantially the same as in the first exemplary embodiment will be omitted. For example, the information processing apparatus according to the present exemplary embodiment has substantially the same hardware configuration as the hardware configuration of the information processing apparatus according to the first exemplary embodiment described above, and the redundant detailed descriptions thereof will be omitted.

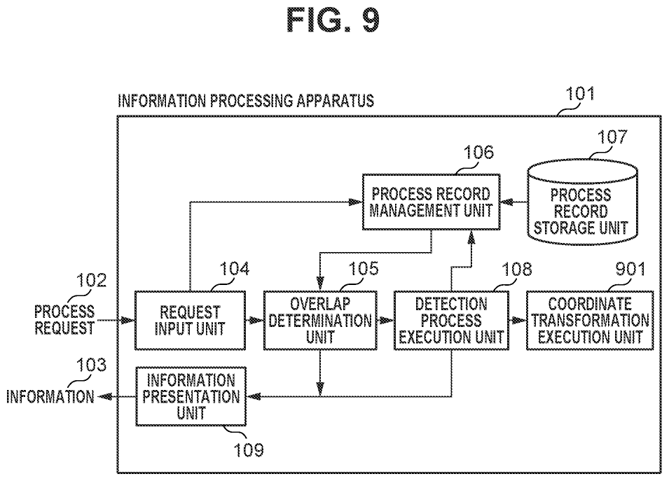

An example of a functional configuration of an information processing apparatus according to the present exemplary embodiment will be described below with reference to FIG. 9.

The information processing apparatus 101 according to the present exemplary embodiment differs from the information processing apparatus 101 according to the first exemplary embodiment described above with reference to FIG. 1 in that the information processing apparatus 101 according to the present exemplary embodiment includes a coordinate transformation execution unit 901.

The coordinate transformation execution unit 901 performs, on the results of the detection processes executed on the partial images by the detection process execution unit 108, a process of transforming information indicating positions in the partial images into information indicating positions in the detection region based on global coordinate information. The global coordinate information is information indicating the positions of the individual partial images in the entire detection region.

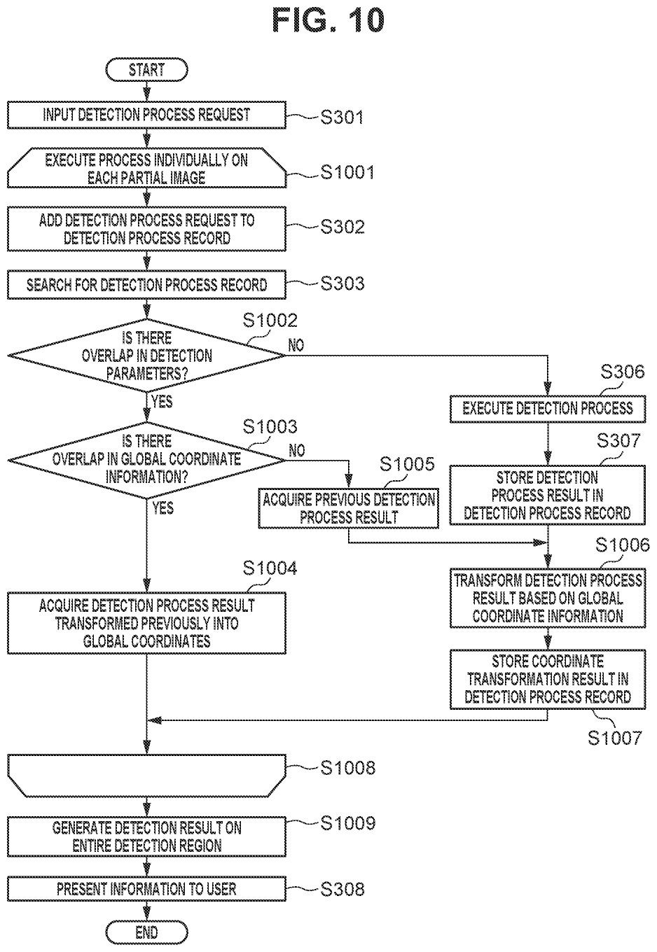

Next, an example of a process performed by the information processing apparatus according to the present exemplary embodiment will be described with reference to FIG. 10. The series of processes illustrated in FIG. 10 differs from the example illustrated in FIG. 3 in that steps S1001 to S1008 are executed individually on each partial image corresponding to a partial region divided from a detection region in a target image and then step S1009 is executed.

Specifically, in step S1002, the overlap determination unit 105 determines whether the detection parameters specified in the target detection process request (the detection process request received in step S301) overlap with detection parameters specified in a detection process request received previously.

In step S1002, if the overlap determination unit 105 determines that the detection parameters specified in the target detection process request overlap with detection parameters specified in a detection process request received previously (YES in step S1002), the processing proceeds to step S1003.

On the other hand, in step S1002, if the overlap determination unit 105 determines that the detection parameters specified in the target detection process request do not overlap with detection parameters specified in a detection process request received previously (NO in step S1002), the processing proceeds to step S306.

In step S1003, the overlap determination unit 105 determines whether the global coordinate information assigned to the partial image overlaps with a result of a previously executed global coordinate transformation (that is to say, global coordinate information applied to a previously executed coordinate transformation).

In step S1003, if the overlap determination unit 105 determines that the global coordinate information assigned to the partial image overlaps with a result of a previously executed global coordinate transformation (YES in step S1003), the processing proceeds to step S1004.

On the other hand, in step S1003, if the overlap determination unit 105 determines that the global coordinate information assigned to the partial image does not overlap with a result of a previously executed global coordinate transformation (NO in step S1003), the processing proceeds to step S1005.

In step S1004, the overlap determination unit 105 acquires, from the target detection process record, a result of a detection process transformed previously into global coordinates.

In step S1005, the overlap determination unit 105 acquires a result of a previous detection process from the target detection process record.

In step S1006, the coordinate transformation execution unit 901 transforms information that indicates a position in the partial image and is included in the result of the detection process on the partial image into information indicating a position in the detection region including the partial image based on the global coordinate information assigned to the partial image. Consequently, the detection process result associated with the position in the partial image is transformed into a detection process result associated with the position in the detection region including the partial image.

In step S1007, the coordinate transformation execution unit 901 requests the process record management unit 106 to store the coordinate transformation result in step S1006 in the target detection process record.

When the series of processes defined by loop ends at steps S1001 and S1008 on each of the series of partial images for which the detection process request is issued is completed, the processing exits from the loop.

Then, in step S1009, the coordinate transformation execution unit 901 generates a detection result on the entire detection region in the image by combining the coordinate transformation results on the individual partial images divided from the same image (target image).

As described above, if a target partial image is added as a result of enlarging the detection region based on an instruction from the user, the information processing apparatus 101 according to the present exemplary embodiment limits the target to the added partial image and applies the detection process and the global coordinate transformation process to the limited target. Further, even if some of the series of partial images included in the detection region is updated or the global coordinate information is corrected, the target can be limited to the some of the partial images, and the detection process and the global coordinate transformation process can be applied to the limited target. Application of the foregoing control makes it possible to generate a detection result on the entire detection region efficiently and then present the detection result to the user.

While the example of the case has been described where the user inputs partial images constituting the detection region and global coordinate information according to the present exemplary embodiment, this is not intended to limit the configuration of and process performed by the information processing apparatus 101 according to the present exemplary embodiment. For example, the information processing apparatus 101 can receive an input of a single image of the entire detection region from the user, divide the image into partial images, and then set each of the divided partial images as a process target. Application of the foregoing control makes it possible to perform the detection process on regions that have not undergone the detection process by the information processing apparatus 101 without the user generating partial images or inputting global coordinate information, providing a detection result on the entire detection region efficiently.

A third exemplary embodiment of the present disclosure will be described. The example has been described of the case where with a detection process request targeting a single image issued, whether there is an overlap in condition between the detection process specified in the detection process request and a detection process executed previously is determined according to the first exemplary embodiment. Meanwhile, there may be a situation in which a request to execute a batch detection process on each of a plurality of images is issued. In this situation, there may be a case where images that have not undergone a detection process and images that have undergone a detection process are mixed, and in this case, the batch detection process may be executed also on the images that have undergone a detection process. Thus, an example will be described of a case where when a batch detection process is applied to a plurality of images, whether there is an overlap in conditions between the detection process specified in the detection process request and a detection process executed previously is determined according to the present exemplary embodiment.

The present exemplary embodiment will be described focusing on differences of the present exemplary embodiment from the first exemplary embodiment, and the redundant detailed descriptions of those that are substantially the same as the first exemplary embodiment will be omitted. For example, the information processing apparatus according to the present exemplary embodiment has substantially the same hardware configuration as the hardware configuration of the information processing apparatus according to the first exemplary embodiment described above, and the redundant detailed descriptions thereof will be omitted.

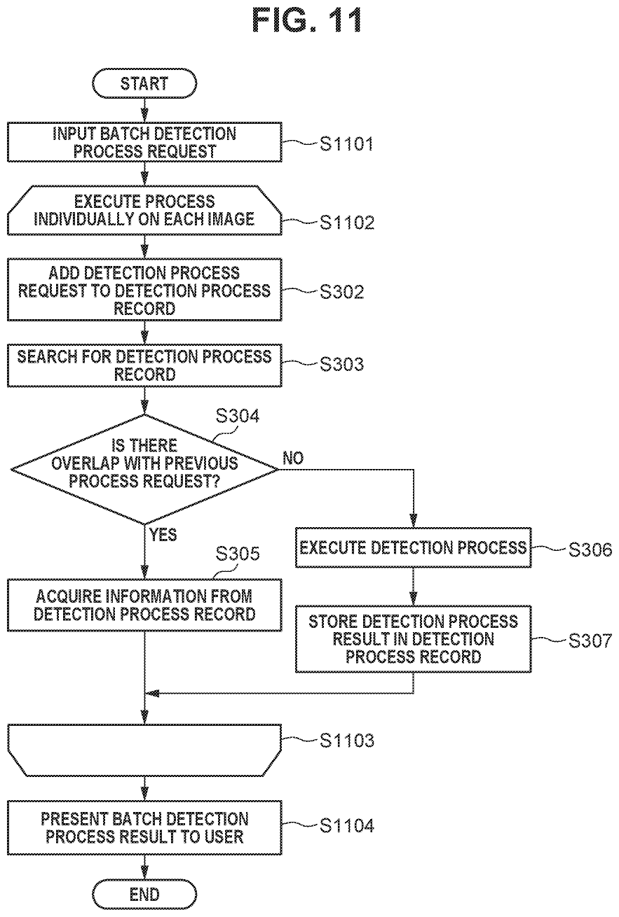

An example of a process performed by the information processing apparatus according to the present exemplary embodiment will be described with reference to FIG. 11. The series of processes illustrated in FIG. 11 differs from the example illustrated in FIG. 3 in that steps S1101 and S1104 and the series of steps S302 to S307 defined by loop ends at steps S1002 and S1103 are executed on each of a plurality of target images.

Specifically, in step S1101, the request input unit 104 receives a request for a batch detection process on a plurality of images.

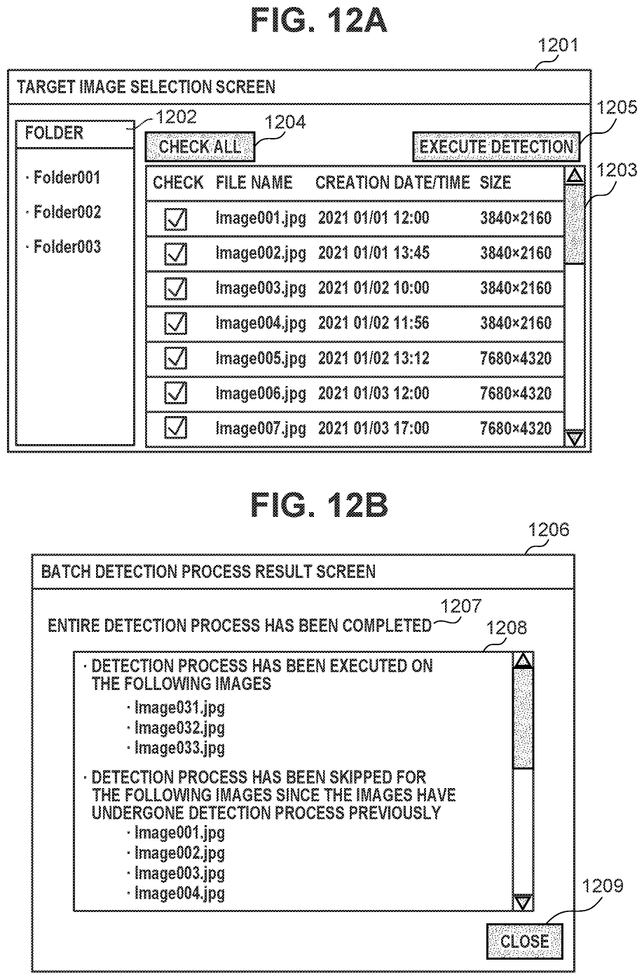

For example, FIG. 12A illustrates an example of a UI for receiving an instruction of a request for a batch detection process on a plurality of images from the user.

A form 1201 is a form for presenting a list of images that are candidates for a target of the detection process to the user and receiving selection of images as a target of the detection process from the user.

A display region 1202 is a display region for presenting a list of folders set to classify images (e.g., images owned by the user) to which the user can refer.

A display region 1203 is a display region for presenting a series of images stored in a folder selected via the display region 1202. Further, the display region 1203 includes an input interface (e.g., checkbox) for receiving selection of images as a target of the batch detection process from the series of images stored in the target folder from the user.

A button 1204 is a button for receiving, from the user, an instruction to select the series of images stored in the folder selected via the display region 1202 as a target of the detection process.

A button 1205 is a button for receiving, from the user, an instruction related to executing the batch detection process on the images selected by the user.

FIG. 11 will be referred to again. According to the present exemplary embodiment, the series of processes (steps S302 to S307) defined by the loop ends at steps S1102 and S1103 is executed on each of the series of images selected in step S1101 individually. Then, if the series of processes on each of the series of images selected in step S1101 is completed, the processing exits from the loop.

Then, in step S1104, the information presentation unit 109 presents, to the user, a result of the batch detection process on each of the series of images selected in step S1101.

For example, FIG. 12B illustrates an example of a UI for presenting, to the user, an execution result of a batch detection process on a plurality of images.

A form 1206 is a form for presenting, to the user, a result of a batch detection process on each of the series of selected images.

A message 1207 is a message notifying the user that the batch detection process has been completed.

A form 1208 is a form for presenting, to the user, detailed information indicating the result of the batch detection process.

A button 1209 is a button for closing the batch detection process result screen illustrated in FIG. 12B.

As described above, the information processing apparatus according to the present exemplary embodiment allows selection of a plurality of images as a target of a detection process. Further, even if a plurality of images is selected as a target of a detection process, the detection process is executed on the images that have not undergone a detection process. Application of the foregoing control makes it possible to prevent an occurrence of an incident where a similar detection process is re-executed on the images that have previously undergone a detection process, providing a result of the detection process on the target images efficiently.

A fourth exemplary embodiment of the present disclosure will be described. The example has been described of the case where process records of detection processes executed previously are searched for prior to execution of a detection process according to the first exemplary embodiment. Meanwhile, with many process records of detection processes executed previously, it takes time to search for a target process record, which may delay the timing of the start of execution of the requested detection process. Thus, an example will be described of a system that allows asynchronous execution of a requested detection process and a detection process record search according to the present exemplary embodiment.

The present exemplary embodiment will be described focusing on differences of the present exemplary embodiment from the first exemplary embodiment, and the redundant detailed descriptions of those that are substantially the same as the first exemplary embodiment will be omitted. For example, the information processing apparatus according to the present exemplary embodiment has substantially the same hardware configuration as the hardware configuration of the information processing apparatus according to the first exemplary embodiment described above, and the redundant detailed descriptions thereof will be omitted.

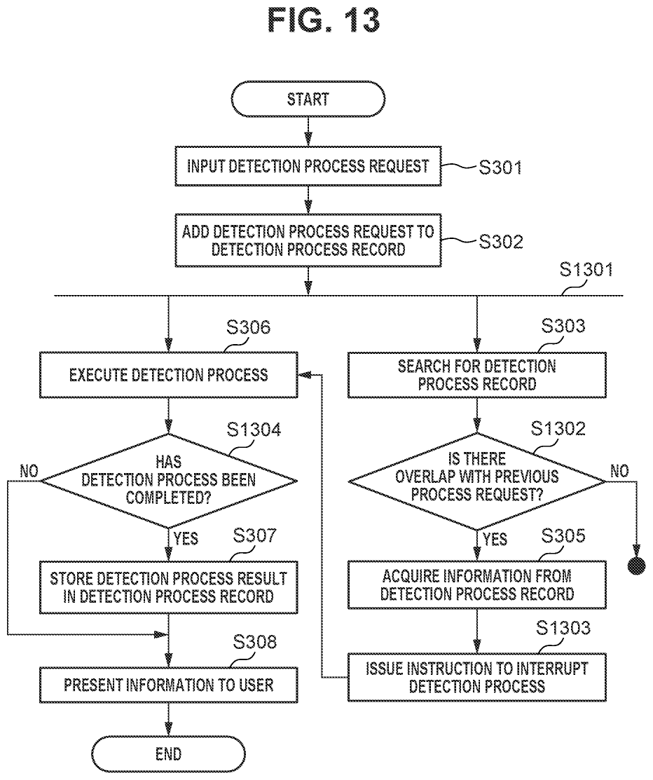

An example of a process performed by the information processing apparatus according to the present exemplary embodiment will be described with reference to FIG. 13. The series of processes illustrated in FIG. 13 differs from the example illustrated in FIG. 3 in that steps S1301, S1302, S1303, and S1304 are added.

Specifically, in step S1301, the information processing apparatus 101 executes steps S303 and S306 asynchronously.

In step S1302, the overlap determination unit 105 determines whether the condition of the detection process specified in the detection process request received in step S301 overlaps with a condition of a detection process executed previously.

In step S1302, if the overlap determination unit 105 determines that the condition of the detection process specified in the detection process request overlaps with a condition of a detection process executed previously (YES in step S1302), the processing proceeds to step S305.

On the other hand, in step S1302, if the overlap determination unit 105 determines that the condition of the detection process specified in the detection process request does not overlap with a condition of a detection process executed previously (NO in step S1302), the ongoing process is ended.

In step S1303, the overlap determination unit 105 transmits information included in the detection process record acquired in step S305 to the detection process execution unit 108 and then instructs the detection process execution unit 108 to interrupt (stop) the detection process.

In step S1304, the detection process execution unit 108 determines whether the ongoing detection process has been completed.

In step S1304, if the detection process execution unit 108 determines that the ongoing detection process has been completed (YES in step S1304), the processing proceeds to step S307.

On the other hand, in step S1304, if an instruction to interrupt the detection process is issued by the overlap determination unit 105 before the ongoing detection process is completed (NO in step S1304), the detection process execution unit 108 interrupts the ongoing detection process, and then the processing proceeds to step S308.

As described above, the information processing apparatus according to the present exemplary embodiment asynchronously executes the overlap determination process involving the detection process record search by the overlap determination unit 105 and the detection process based on the detection process request by the detection process execution unit 108. Application of the foregoing control allows the detection process execution unit 108 to initiate the detection process based on the detection process request without waiting for a result of the overlap determination process performed by the overlap determination unit 105, whereby an effect of expediting the series of processes can be expected.

A fifth exemplary embodiment of the present disclosure will be described. The example has been described of the case where an execution result of the detection process is displayed through the execution of a detection process according to the first exemplary embodiment.

Meanwhile, for example, there may be a situation in which comparisons of results of detection processes on similar images using the same condition (e.g., same parameters) are performed in order to observe changes in the same detection region over time. Further, as another example, there may be a situation in which comparisons of results of detection processes that differ in process version from each other are performed to check variations in the visualized results of the detection processes due to the difference in process version. Given such situations, an example will be described of a system according to the present exemplary embodiment that allows comparison with a result of a detection process executed previously in presenting detection process information to the user.

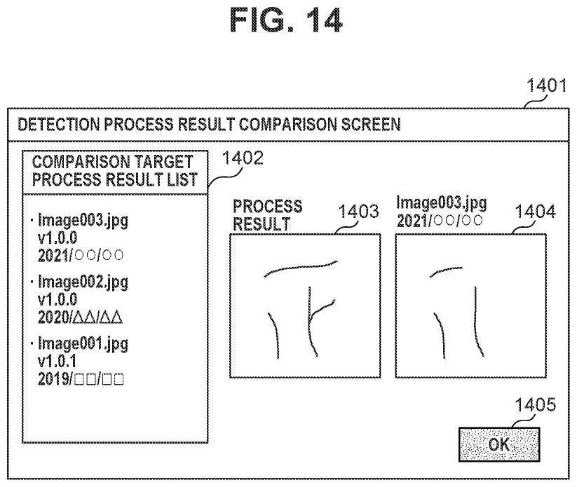

A detection process result comparison screen that allows comparison with a result of a detection process executed previously in presenting a result of a detection process will be described with referenced to FIG. 14 as an example of a UI of the information processing apparatus 101 according to the present exemplary embodiment.

A form 1401 is a form for displaying a plurality of detection process results so that the plurality of detection process results can be compared with each other.

A display region 1402 is a display region for presenting a list of detection process results (e.g., a target image and a result of a detection process on the image) that are candidates for a comparison target.

A display region 1403 is a display region for displaying a result of a detection process executed based on a detection process request.

A display region 1404 is a display region for displaying a detection process result selected as a comparison target.

A button 1405 is a button for closing the detection process result comparison screen.

The candidates that are presented as a comparison target in the display region 1402 can be controlled based on various conditions. For example, the information processing apparatus 101 can extract a result of another detection process with a condition at least some of which is similar to a condition of a result of a detection process executed based on a detection process request and present the extracted result of the detection process as a comparison target candidate in the display region 1402.

As a specific example, the information processing apparatus 101 can present, as a candidate for a comparison target, a result of a detection process executed on another image similar to a target image of a detection process executed based on a detection process request using the same parameters as in the detection process executed based on the detection process request.

In this case, the information processing apparatus 101 can determine that a plurality of comparison target images is similar to each other when, for example, the difference between feature amounts extracted individually from the plurality of comparison target images is less than or equal to a threshold.

Further, as another example, the information processing apparatus 101 can determine whether a plurality of images is similar to each other using position information that is associated individually with each of the plurality of images and is about an imaging apparatus that has captured the image. Specifically, if the positions of the imaging apparatuses that have captured the plurality of images match or are close to each other, it can be assumed that the same subject is captured. Thus, for example, if the difference between the position information associated with the plurality of images is less than or equal to the threshold, the information processing apparatus 101 can determine that the plurality of images is similar to each other.

Further, as yet another example, the information processing apparatus 101 can present, as a candidate for a comparison target, a result of a detection process on the same image as a detection process executed based on a detection process request with a condition at least some of which differs from a condition of a detection process executed based on a detection process request.

As a specific example, the information processing apparatus 101 can present, as a candidate for a comparison target, a result of a detection process on the same image with the same parameters as in a detection process executed based on a detection process request and with a different process version from the process version of a detection process executed based on a detection process request.

Further, as yet another example, the information processing apparatus 101 can present, as a candidate for a comparison target, a result of a detection process on the same image as in a detection process executed based on a detection process request with a series of parameters some of which differs from the series of parameters of a detection process executed based on a detection process request.

As described above, the information processing apparatus 101 according to the present exemplary embodiment allows presentation of, to the user, a result of a detection process executed based on a detection process request and a result of a detection process executed previously so that the user can compare the results. This makes it possible to present, for example, a result of a detection process executed on a similar image using the same parameters as in a result of a detection process executed based on a detection process request or a result of a detection process with a different process version from a process version of a detection process executed based on a detection process request so that the user can compare the results.

A sixth exemplary embodiment of the present disclosure will be described. The example has been described of the case where a result image with a result of a detection process superimposed on a target image of the detection process is stored as a process record and presented to the user according to the first exemplary embodiment. Meanwhile, there may be a situation in which an image with high resolution and large file size is used as a detection process target in order to enhance accuracy related to detection of objects from images. In such a situation, storing the result image with the result of the detection process superimposed on the target image of the detection process increases the size of data stored as process records, resulting in an increased management cost.

Given the foregoing situations, the information processing apparatus 101 according to the present exemplary embodiment can store the result of the detection process as data in a predetermined format (e.g., data of relatively small size, such as a text file) without storing the result image with the detection process result superimposed thereon. In this case, the information processing apparatus 101 can edit the image specified in the detection process request based on the stored data to generate a result image with the detection process result superimposed on the image and then present the result image to the user.

Application of the foregoing control makes it unnecessary to store the result image with the detection process result superimposed thereon as a record, so that the size of data stored as the record further decreases, whereby an effect of reducing management cost can be expected.

According to the present exemplary embodiment, an image specified in a detection process request corresponds to an example of “first image”, and a result image with a result of a detection process superimposed on the first image corresponds to an example of “second image”.

A seventh exemplary embodiment of the present disclosure will be described. According to the first exemplary embodiment, the determination of whether there is an overlap in conditions between a detection process specified in a detection process request and a detection process executed previously is performed on the entire detection process records. Meanwhile, as the number of results of previously executed detection processes stored as detection process records increases, it takes a longer time to search for the results of the detection processes, which may delay the start of execution of the detection process based on the detection process request.

Given the foregoing situations, the information processing apparatus 101 according to the present exemplary embodiment can limit the search target range of the detection process records by specifying search conditions in searching the results of the previously executed detection processes.

As a specific example, the information processing apparatus 101 can limit the search target range of the detection process records by using, as a search condition, information indicating a date and time of generation of a file of a detection process target image that is stored in the file. As a more specific example, it is less likely that a detection process is executed on an image specified by an image file before the date and time of generation of the image file. Thus, for example, the information processing apparatus 101 can reduce the number of detection process records that are a search target by applying a filter using the date and time of generation of the target image file as a condition to the series of detection process records.

Further, inspections of constructions, determinations of crops, and determinations of lesions in the medical field are often executed repeatedly over a relatively short span. Thus, in such use cases, the detection process record search can be performed with priority on a date and time that are closer to the date and time of generation of the image file. As a specific example, the information processing apparatus 101 can perform the detection process record search to extract a predetermined number of detection process records with priority on a date and time closer to the date and time of generation of the image file. Applying the foregoing control can lead to an expectation of an effect of increasing the speed of searching the results of previously executed detection processes.

### Other Exemplary Embodiments

While the exemplary embodiments have been described in detail above, in the present disclosure, an exemplary embodiment can be implemented as, for example, a system, an apparatus, a method, a program, or a recording medium (storage medium). Specifically, the present disclosure is applicable to a system including a plurality of devices (e.g., host computer, interface device, imaging apparatus, web application) or an apparatus consisting of a single device.

Further, it is apparent that the aim of the present disclosure is achieved as described below. Specifically, a recording medium (or a storage medium) recording program codes (computer program) of software that realizes the functions of the exemplary embodiments described above is supplied to a system or an apparatus. It goes without saying that the storage medium is a computer-readable storage medium. Then, a computer (or a CPU or a micro-processing unit (MPU)) of the system or the apparatus reads the program codes stored in the recording medium and executes the read program codes. In this case, the program codes read from the recording medium realize the functions of the exemplary embodiments described above. Thus, the recording medium recording the program codes is included in the present disclosure.

Further, various changes can be applied without departing from the basic technical concepts of the technologies according to the exemplary embodiments of the present disclosure.

For example, control specific to a use case to which the technologies according to the present disclosure are applied can be customized based on the technologies according to the present disclosure and applied. As a specific example, a service that determines a fee based on the number of times the user executes a process is provided as a pay-as-you-go cloud service. Such a charging system can be applied to the information processing apparatus 101 according to an exemplary embodiment of the present disclosure. As a specific example, different fees can be applied between a case where a detection process is actually executed and then a result of the detection process is presented and a case where a result of a detection result executed previously using a similar condition is detected through an overlap determination process and the detected result of the detection process is presented.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-065876, which was filed on Apr. 13, 2023 and which is hereby incorporated by reference herein in its entirety.

What is claimed is:

1. An information processing apparatus comprising:
one or more memories storing instructions, and one or more processors that execute the instructions to:
determine whether a series of records of a previously executed detection process related to detection of a detection target from an image includes a record of a second detection process with a condition related to the detection of the detection target from the image, at least some of which overlaps with a condition of a first detection process based on a process request from a user; and
present information about the second detection process to the user in a case where it is determined that the record of the second detection process with the condition at least some of which overlaps with the condition of the first detection process is included.

2. The information processing apparatus according to claim 1, wherein the information about the second detection process is information indicating that the second detection process with the condition at least some of which overlaps with the condition of the first detection process has been executed.

3. The information processing apparatus according to claim 1, wherein the series of records includes information about a result of the second detection process executed previously.

4. The information processing apparatus according to claim 1,
wherein the one or more processors execute the instructions to determine whether a pending or ongoing detection process includes a third detection process with a condition at least some of which overlaps with the condition of the first detection process, and
wherein in a case where it is determined that the third detection process with the condition at least some of which overlaps with the condition of the first detection process is included, information about the third detection process is presented to the user.

5. The information processing apparatus according to claim 4, wherein the information about the third detection process includes at least information indicating a progress status of the third detection process.

6. The information processing apparatus according to claim 1,
wherein the series of records includes information indicating a version of a library applied to a target detection process,
wherein the one or more processors execute the instructions to perform a version comparison between the first detection process and the second detection process with the condition at least some of which overlaps with the condition of the first detection process, and
wherein in a case where it is determined that the first detection process and the second detection process differ in version from each other, information for checking whether to execute the first detection process is presented to the user.

7. The information processing apparatus according to claim 1,
wherein the one or more processors execute the instructions to determine, individually for each partial image divided from a detection region in an image specified by the process request, whether the record of the second detection process with the condition at least some of which overlaps with the condition of the first detection process on the partial image is included,
wherein the first detection process is executed on a first partial image for which it has been determined that the record of the second detection process with the condition at least some of which overlaps with the condition of the first detection process is not included,
wherein information indicating a position in the first partial image that is included in information indicating a result of the first detection process is transformed into information indicating a position in the detection region including the first partial image based on coordinate information associating the position in the target partial image with the position in the detection region, and
wherein the information indicating the result of the first detection process on the first partial image that has undergone the transformation of the information indicating the position and information indicating a result of the second detection process on a second partial image other than the first partial image in the detection region are presented to the user as information indicating a result of a process on the detection region.

8. The information processing apparatus according to claim 7,
wherein the one or more processors execute the instructions to transform information indicating a position in an image that is included in the result of the second detection process to which second coordinate information different from first coordinate information applied to the result of the first detection process on the first partial image has been applied among the result of the second detection process in which it is determined that at least some of the condition overlaps with the condition of the first detection process into information indicating a position in the detection region based on the first coordinate information, and
wherein the information indicating the result of the process on the detection region that includes at least the information indicating the result of the second detection process that has undergone the transformation of information indicating a position in a target image into information indicating a position in the detection region based on the first coordinate information is presented to the user.

9. The information processing apparatus according to claim 1,
wherein the process request specifies a plurality of images as a target of the detection process related to the detection of the detection target from the image, and
wherein the one or more processors execute the instructions to:
determine, individually for each of the plurality of images, whether the series of records includes the record of the second detection process with the condition at least some of which overlaps with the condition of the first detection process on the image; and
execute the first detection process on the image for which it has been determined that the record of the second detection process with the condition at least some of which overlaps with the condition of the first detection process is not included, and
wherein the one or more processors execute the instructions to present, to the user, information about the image determined to be a target of the first detection process and information about the image not determined to be a target of the first detection process.

10. The information processing apparatus according to claim 1, wherein the one or more processors execute the instructions to:
execute, asynchronously with the first detection process based on the process request, a process of determining whether the series of records includes the record of the second detection process with the condition at least some of which overlaps with the condition of the first detection process; and
stop the first detection process that is ongoing in a case where it is determined that the record of the second detection process with the condition at least some of which overlaps with the condition of the first detection process is included.

11. The information processing apparatus according to claim 1, wherein the one or more processors execute the instructions to present, to the user, a result of the first detection process based on the process request and a result of a detection process executed previously on another image similar to an image that is a target of the first detection process.

12. The information processing apparatus according to claim 1, wherein the one or more processors execute the instructions to present, to the user, a result of the first detection process based on the process request and a result of another detection process differing in version of an applied library from the first detection process.

13. The information processing apparatus according to claim 1, wherein the one or more processors execute the instructions to:
generate a second image with a result of the first detection process superimposed on a first image that is a target of the first detection process based on the process request; and
present the generated second image to the user.

14. The information processing apparatus according to claim 1, wherein the one or more processors execute the instructions to determine whether the record of the second detection process is included in the series of records of the detection process executed after a date and time of generation of an image that is a target of the first detection process based on the process request.

15. The information processing apparatus according to claim 1, wherein the one or more processors execute the instructions to determine whether the record of the second detection process is included with priority on the records of the detection process executed at a closer date and time to a date and time of generation of an image that is a target of the first detection process based on the process request.

16. The information processing apparatus according to claim 1, wherein the one or more processors execute the instructions to apply a fee that varies between a case where the first detection process based on the process request is executed and a case where the information about the second detection process with the condition at least some of which overlaps with the condition of the first detection process is presented.

17. A method for controlling an information processing apparatus, the method comprising:
determining whether a series of records of a previously executed detection process related to detection of a detection target from an image includes a record of a second detection process with a condition related to the detection of the detection target from the image, at least some of which overlaps with a condition of a first detection process based on a process request from a user; and
presenting information about the second detection process to the user in a case where it is determined that the record of the second detection process with the condition at least some of which overlaps with the condition of the first detection process is included.

18. A non-transitory computer-readable storage medium storing a computer-executable instructions for causing a computer to perform operations comprising:
determining whether a series of records of a previously executed detection process related to detection of a detection target from an image includes a record of a second detection process with a condition related to the detection of the detection target from the image, at least some of which overlaps with a condition of a first detection process based on a process request from a user; and
presenting information about the second detection process to the user in a case where it is determined that the record of the second detection process with the condition at least some of which overlaps with the condition of the first detection process is included.
